(19) United States
(12) Patent Application Publication
(10) Pub. No.: US 2022/0288862 A1
(43) Pub. Date: Sep. 15, 2022

(54) THERMAL INTERACTIONS

(71) Applicant: HEWLETT-PACKARD DEVELOPMENT COMPANY, L.P., Spring, TX (US)

(72) Inventors: Quim MUNTAL DIAZ, Sant Cugat del Valles (ES); Jordi SANROMA GARRIT, Sant Cugat del Valles (ES); Josep M. ASENSIO BUCHACA, Sant Cugat del Valles (ES)

(21) Appl. No.: 17/637,547

(22) PCT Filed: Oct. 30, 2019
(86) PCT No.: PCT/US2019/058785

§ 371 Date: Feb. 23, 2022

(51) Int. Cl. B29C 64/393; G06F 30/27

(52) U.S. Cl. CPC B29C 64/393; G06F 30/27; G06F 2113/10

(57) ABSTRACT

In an example, a method includes determining a training dataset for an inference model to evaluate spatial arrangements of objects to be generated in additive manufacturing. Determining the training dataset may include obtaining, by at least one processor, a temperature distribution for each of a plurality of spatial arrangements of objects to be generated in additive manufacturing. The method may further include obtaining, using at least one processor, an indication of thermal interaction for each spatial arrangement based on the obtained temperature distribution.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example method for use in determining a training dataset;

FIG. 2 is simplified schematic drawing of an example build volume of a fabrication chamber;

FIG. 3 is a flowchart of an example method for determining an inference model;

FIG. 4 is a flowchart of an example method of selecting a spatial arrangement of objects to be generated;

FIG. 5 is a flowchart of an example method of selecting and determining a spatial arrangement of objects;

FIGS. 6 and 7 are simplified schematic drawings of example apparatus for additive manufacturing; and

FIG. 8 is a simplified schematic drawing of an example machine readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be determined from structural design data). The fusing agent may have a composition which absorbs energy such that, when energy (for example, heat) is applied to the layer, the build material to which it has been applied heats up, coalesces and solidifies, upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. Such a fusing agent may comprise any or any combination of an infra-red light absorber, a near infra-red light absorber, a visible light absorber and a UV light absorber. Examples of fusing agents comprising visible light absorption enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed to reduce coalescence. According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer determining a three-dimensional model of an object to be generated, for example using a computer aided design (CAD) application. The model may define the solid portions of the object. To generate a three-dimensional object from the model using an additive manufacturing system, the model data can be processed to define slices or parallel planes of the model. Each slice may define a portion of a respective layer of build material that is to be solidified or caused to coalesce by the additive manufacturing system.

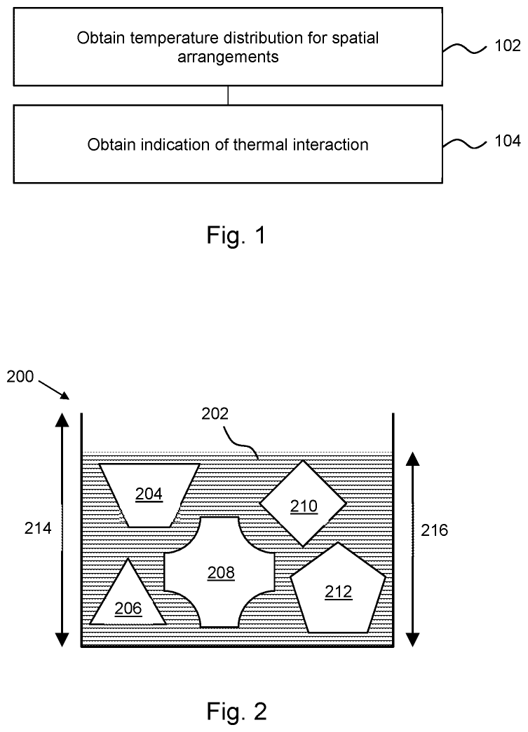

FIG. 1 is an example of a method, which may comprise a computer implemented method for determining a training dataset for an inference model to evaluate spatial arrangements of objects to be generated in additive manufacturing. A ‘training dataset’ in this context is a set of data which is processed to allow the inference model to be ‘learnt’ using one or more data fitting and/or machine learning techniques, such as SVM (Support Vector Machine), Regression Tree, or CNN (Convolutional Neural Network). In this example, the relationships between parameters which are specified for the training datasets.

The method may make use of data gathered from a set of objects generated using an additive manufacturing process and/or from simulations of such an additive manufacturing process. In some examples, these may be generated using, or simulated based on, the same class of additive manufacturing process. For example, all the objects may be generated using, or simulated based on, selective laser sintering, or all the objects may be generated using, or simulated based on, a fusing agent printed onto a layer of build material, or all the objects may be generated using, or simulated based on, some other additive manufacturing process. In other examples, all the objects may be generated, or simulated based on, using a particular class of apparatus, for example, a powder and fusing agent based 3D printing system. In some examples, all the objects may be generated using, or simulated based on, the same instance of an additive manufacturing apparatus (i.e. a particular 3D printer). In some examples, all the objects may be generated using, or simulated based on, use of particular build materials. The method comprises, in block 102 obtaining, by at least one processor, a temperature distribution for each of a plurality of spatial arrangements of objects to be generated in additive manufacturing. The spatial arrangements may for example comprise a data model of a virtual fabrication chamber containing one or more virtual objects (or object models). The obtained temperature distribution may be based on a computer model simulating temperatures during a build process, and/or may be based at least partially on measured temperatures of build material during a build process. The temperature distribution may describe the actual (i.e. measured), or expected temperature for a region of build material. In some examples, the regions may comprise Voxels' i.e. three-dimensional pixels defined at a selected print resolution of an additive manufacturing system. However, in some examples, the temperature distribution may be obtained (i.e. measured or simulated) at a lower resolution such that the temperature distribution is described at a lower resolution than the resolution achievable by the additive manufacturing apparatus. The temperature distribution may be time dependent, such that the temperature distribution may describe how the temperature changes throughout an object generation process. For example, heat diffusion models may be used to simulate how heat may diffuse through a build material overtime. In some examples a combination of measured data and simulated data may be used to obtain the temperature distributions for each of the plurality of spatial arrangements of objects.

The method comprises, in block 104, obtaining, using at least one processor, an indication of thermal interaction for each spatial arrangement based on the obtained temperature distribution. The indication of thermal interaction may provide ‘thermal score’ indicative of the thermal behaviour of the arrangement, wherein arrangements which score well are likely to result in better (e.g. more dimensionally accurate) objects than those which score poorly. The indication of thermal interaction may indicate how temperatures within the build volume change over time. In some examples, the indication of thermal interaction may indicate thermal interactions between objects, for example be a measure of, how a second object to be generated is affected by heat from generation of a first object, or more generally how the presence of at least one other object impacts at least one other object. For example, generation of objects may comprise application or generation of heat, and therefore generation of one object may affect the temperature of build material close thereto. However, the quality of the generated objects may be dependent on achieving a specific temperature distribution throughout the object generation process. For example, it may be intended that the temperature distribution is relatively smooth, such that thermal gradients are relatively minimal. Therefore, if objects are built in close proximity such that heat from generation of a second object results in unwanted or unanticipated heating of the first object, the first and/or second object may have a reduced build quality when compared to object generation without the other object being present. For example, if the temperature of build material in the vicinity of the second object is raised above its fusing temperature due to heating by the first object, then the additional build material may solidify resulting in unwanted artefacts on the surface of the second object. In other examples, part quality may be reduced due to deformations in the intended geometry of the objects. For example, differential heating may result in warpage associated with shrinkage as the parts of the object cool at different rates. In other examples unfused build material may be rendered unrecyclable due to excess heat being applied to it. Such differential heating, or hot spots in the object generation process, may result in thermal stress, which it may be intended to control, reduce or avoid in additive manufacturing.

The indication of thermal interaction may therefore provide a measure of how heat from the generation of object(s) within the fabrication chamber affects other object(s) within the same fabrication chamber and/or how thermal stress may impact the build quality. In some examples the indication of thermal interaction is a numerical value, and in some examples a low indication of thermal interaction may correlate with a low amount of thermal interaction between objects and/or a low amount of thermal stress and therefore higher quality of generated objects. For example, the indication of thermal interaction may take into account, or be impacted by object separation, object volume (e.g. bulkier objects may result in more heating), object geometry; object generation parameters and the like, as set out in greater detail below.

Each spatial arrangement may contain a plurality of training objects. In some examples, the training objects may be virtual objects, i.e. data models of objects arranged in a ‘virtual’ fabrication chamber. In some examples the training objects in each arrangement are identical, but with different positions and/or orientations. In other examples different spatial arrangements may comprise different training objects. The different objects may in some examples be different sizes and/or shapes. The training objects used in generating, or determining, the training set may be selected based on the types of objects which are intended to be generated, and for which the inference model is to be used. For example, the training set may comprise training objects which have been previously generated in additive manufacturing. In some examples, it may be intended to repeatedly generate a ‘batch’ or set of objects, and the training objects may comprise objects from the batch. In other examples the objects used in creating the training dataset may be randomly determined/generated, for example by placing objects of random size and shape within a build volume. The set of objects used in creating the training dataset may comprise tens, hundreds or 1,000 objects or more.

The spatial arrangements of the objects may be created by positioning the training objects within a build volume, for example randomly. In some examples the objects may not be placed entirely randomly, for example the spatial distributions may be checked for collisions between objects (i.e. the objects do not intersect each other), or the spatial arrangements may be determined by a set of rules, for example by placing objects within the build volume with approximately equidistant spacing and/or with maximal spacing. In some examples, one spatial arrangement may be related to another, for example comprising objects having roughly the same position, but being relatively rotated.

A large number of spatial arrangements may be obtained/defined to determine the training dataset. In some examples hundreds, thousants, 100,000 or more spatial arrangements may be obtained/defined to generate the training dataset. By including ‘simulated’ build volumes, (i.e. build volumes which are not intended for actual object generation), a large amount of training data may be acquired. The spatial arrangements for the training dataset may be obtained by creating arrangements of objects from a library of virtual objects. For example, a library of virtual objects may model over 20,000 different objects which may represent typical objects to be generated. The objects from the library may be combined with information about how users make use of the additive manufacturing apparatus. For example, the information may include the number of objects generated in a build process, the positions of the objects within a build volume, surface area of the objects which are generated, volume of the objects and/or bounding boxes of the objects (a volume surrounding an object which other objects are excluded from being located within). The spatial arrangements may be automatically determined, for example based on the information. Such spatial arrangements can be representative of the types of arrangements which are used by users, and so are effective for use in training an inference model. In other words, ‘statistics’ of actual build operations (i.e. data characterising one or more features of build operations, which may contain data at a level such that details of individual build operations is at least somewhat obscured) carried out by users may be collected and used in determining example spatial arrangements for use in generating training data. As these are based on ‘real’ example use cases. Such training data is likely to appropriately represent future use cases.

FIG. 2 shows an example of a cross section of build volume 200 of a fabrication chamber of an additive manufacturing apparatus. The build volume 200 comprises build material 202 which is deposited in layers, which in this example are shown as horizontal lines. The direction perpendicular to the layers is referred to herein as the z-direction, and the two orthogonal directions parallel to the layers of build material are referred to herein as the x-direction and y-direction. As described above the build material may be deposited in layers onto which fusing agent may be selectively distributed onto portions of a layer to cause those portions to solidify to form a slice of an object to be generated.

Evaluation of candidate virtual build volumes, which may be described as a nesting or object batching process, has been proposed, which may seek to optimise (in some examples, within constraints) certain criteria. For example, such candidate build volumes may be evaluated to determine how efficiently they use the space available in a build volume. Candidate virtual build volumes may be compared such that the build volume in which a certain number of objects can be generated in a minimum height is identified, as the lower the height of the build volume, the faster the build volume may be generated.

In such cases, ‘nesting’ analysis has, for example, been carried out to converge on a selected candidate virtual build volume which seeks to minimise a target function which depends on parameters such as the height of the virtual build volume, the number of objects contained within the build volume and/or the density of objects. In some examples, this is carried out by determining a random initial solution for the arrangement (which may satisfy some basic criteria such as being contained within a printable volume and having objects which do not intersect), and determining a score for the candidate virtual build volume based on a predetermined target function. The candidate virtual build volume may then be ‘shuffled’, for example by applying a random rotation to object(s) (and in some examples, validating that the new object placement remains inside the printable volume and does not result in an intersection between objects), and the shuffled candidate virtual build volume is then scored again. This process may continue until, for example, a threshold parameter is achieved, or the best score (for example the minimum or maximum score) after a predetermined number of iterations may be selected. In other examples the objects may be moved in some non-random way within the build volume rather than random shuffling, in order to create a new candidate build volume.

FIG. 2 shows a cross section of a build volume 200, showing a spatial arrangement of objects 204-212. In this example the spatial arrangement of objects 204-212 is an arrangement of objects within a fabrication chamber of an additive manufacturing apparatus. In this example there are five objects: a first object 204 which has a trapezium cross section, a second object 206 with a triangular cross section, a third object 208 with a cross shaped cross section, a fourth object 210 with a square (or diamond) shaped cross section and a fifth object 212 with a pentagon shaped cross section. In this example the objects 204-212 are arranged such that they all fit within the build volume 200 and so may be generated in a single additive manufacturing process. However, in some examples it may be intended to build more objects than can fit within a single build volume 200, which will result in having to perform multiple builds. Performing multiple builds can significantly increase the cost and time to generate objects so where possible objects are nested to fit an intended number of objects within a single build volume.

In this example, the build volume 200 has a maximum depth 214 of build material 202. As can be seen, in this example spatial arrangement of objects, the actual depth 216 of build material used is less than the maximum depth 214. By using a build material depth of less than the maximum depth 214 a smaller volume of build material is used, which can reduce the cost and time to build the objects 204-212.

A candidate build volume showing an arrangement of objects in a virtual model of the build volume shown in FIG. 2 may be evaluated prior to generation against various criteria to determine whether this particular spatial arrangement is used, as will be described in more detail below in reference to FIGS. 4 to 8.

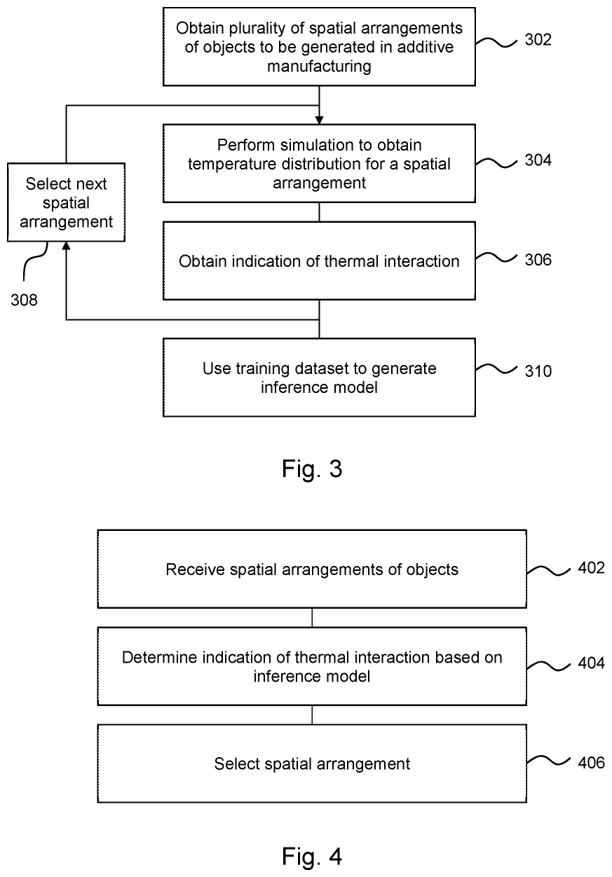

FIG. 3 shows an example of a process which may comprise a computer implemented method for determining a training dataset for an inference model to evaluate spatial arrangements of objects to be generated in additive manufacturing, and generating (or determining) the model.

Block 302 comprises obtaining a plurality of spatial arrangements of objects to be generated in additive manufacturing, and may correspond to block 102 of FIG. 1.

In some examples, instead of characterising the spatial arrangement in its entirety, a set of features of a spatial arrangement of objects is obtained and associated with that spatial arrangement for use in determination (e.g. training) of an inference model. The set of features may comprise at least one of: an indication of the intended specified position of objects (e.g. their specified relative positions of objects in the additive manufacturing fabrication chamber) and indication of object geometry (e.g. any or any combination of the volumes of the objects, hollowness of the objects, object dimension ratio, moments of inertia of the objects) and/or object generation parameters (e.g. materials to be used in generating the objects, apparatus heating parameters, or the like). The indication of the relative position of objects may be based on a determination of the closest distance between the two objects, however this may be computationally expensive to calculate so the relative position of two objects may be determined by determining the distance between the center of mass, or geometrical center, of the two objects. Other geometrical descriptors may also be considered when determining the proximity of two objects, for example the volume of the objects, the surface area of the objects or a measure of the hollowness of the objects.

In an example, the features extracted comprise an indication of the relative object placement, an indication of object geometry, and an indication of at least one parameter of object generation.

For example, the indication of relative placement may comprise an indication of the location of the centre of mass (for example in x, y, z coordinates) of each object within the virtual build volume. This may provide an indication of object separation. The indication of object geometry may comprise any or all of: (i) surface area of the objects, (ii) volume of the objects, (iii) convex hull area and (iv) convex hull volume, wherein a convex hull is the smallest convex surface which can enclose an object. The combination of object volume and object surface area may provide an indication of how much energy an object may be received during object generation, and how that energy may diffuse. The actual geometry and the geometry of the convex hull may both provide indicators of different aspects of thermal interactions, and therefore in some examples, the set of features may comprise features relating to both geometries. The indication of the object generation parameter may comprise a choice of build material (or an attribute thereof, such as thermal diffusivity). In one example, all these features are extracted and used in the training data set. Each of the mentioned features may have a significant impact on the thermal distribution and thermal interactions within a build volume. However, any other features which may be related to thermal interactions may be considered additionally or alternatively.

In a particular example, the set of features comprises (i) the location of the centre of mass (for example in x, y, z coordinates); (ii) surface area of the objects, (iii) volume of the objects, (iv) convex hull area; (v) convex hull volume and (vi) at least one parameter of the build material (e.g., its thermal properties, or its identity).

Block 304 comprises obtaining a temperature distribution by performing a simulation to model the temperature distribution for a spatial arrangement of objects to be generated. A spatial arrangement may be described by a voxelised model of objects within a fabrication chamber. In such a model each layer of build material within the fabrication chamber may be represented by a layer of voxels extending in the x- and y-directions, and each layer is stacked in the z-direction. Voxels which correspond to objects to be generated correspond to sub-volumes of the fabrication chamber which comprise build material to be solidified. In some examples, the build material to be solidified is solidified by application of a fusing agent and/or heat. Therefore, to simulate the temperature distribution, a simulation may be performed which models the effects of applying heat to voxels corresponding to objects to be generated in a layer-wise manner, and modelling how the applied heat affects the temperature of other voxels.

The simulation may for example be a Finite Element Method (FEM) simulation, for example based on the time-temperature superposition concept and/or Arrhenius law. The simulation may be performed at the same voxel resolution at which the additive manufacturing apparatus generates objects or may be performed at other resolutions. The resolution may be selected based on a consideration of the relative importance of speed or precision, and in some examples may be lower than that of the additive manufacturing apparatus.

Performing the simulation may comprise simulating heat transfer and temperature for each voxel of the build volume. For example, each voxel which corresponds to an object, and therefore is intended to be solidified may be considered as a point source of heat. How the heat spreads to adjacent voxels and throughout the build volume may be modelled by applying a convolution kernel to the voxelised model.

A convolution kernel may be applied to the initial model of at least one layer of the object model. The convolution kernel may comprise a function modelling how temperatures evolve over time as the heat spreads through the build material and may have a spatial and time dependency, for example the convolution kernel may be a Gaussian function which has a width that increases with time to simulate heat diffusing throughout the build material. For example, if heat is applied by a point source within the build material, the surrounding material would heat up and increase in temperature over time as the heat conducts through the material. In an (unlikely) example where material corresponding to a single voxel is to be solidified, this would generally be hotter than its surroundings, so would radiate heat to these surroundings, increasing the temperature thereof while itself cooling. In practice, regions may absorb heat from, or lose heat to, surrounding regions depending on factors such as their mutual temperature difference and the thermal diffusivity of the material, and at a rate depending on factors such as the build material type.

In other examples temperature distributions may be obtained by obtaining measurements during an object generation operation, for example using thermal cameras or the like. Such measurements may also be used in developing models for simulating temperature distributions.

Block 306 comprises obtaining an indication of thermal interaction. The indication of thermal interaction may be obtained as an output of the simulation performed in block 304, or may be obtained by further processing the output of the simulation, for example to determine an indication of thermal interaction between the objects and/or thermal stress. For example, the simulation may result in a temperature distribution, which is further processed to obtain the indication of thermal interaction.

As noted above, the indication of thermal interaction may be based, at least in part, on a determination of thermal stress within the build volume. For example, the simulation may be used to determine the indication of thermal interaction from the accumulated thermal stress of the build volume during a build process. Thermal stress is the stress created by change in temperature of the build material during the build process and depends on the thermal expansion coefficient of the build material and the temperature distributions throughout the build process.

In some examples the indication of thermal interaction may be obtained by evaluating the diffusion of heat throughout the build volume. For example, a comparison may be made between the difference in temperature of a portion of a first object when a second object is present within the build volume and when the second object is not present within the build volume. If there is a relatively small difference in temperature of the portion of the first object the indication of thermal interaction may be low, whereas if the presence of the second object causes a large difference in temperature of the portion of the first object then the indication of thermal interaction may be large. This may for example be repeated for all the objects in the spatial arrangement.

In other examples, the indication of thermal interaction may be a measure indicating thermal gradients, for example evaluating an average temperature difference between objects.

The method then continues to block 308 wherein a next spatial arrangement is selected. The method then repeats blocks 304 and 306 for the selected spatial arrangement. The method repeats these blocks iteratively, such that a simulation is performed to model the temperature distribution for each of the spatial arrangements, and for each of the spatial arrangements, an indication of thermal interaction is obtained.

When a simulation has been performed and an indication of thermal interaction obtained for each spatial arrangement the method proceeds to block 310 which comprises using the training dataset to determine (e.g. generate or train) an inference model which is to indicate, for a given spatial arrangement of objects within a fabrication chamber during object generation, an indication of thermal interaction. The model may be determined using any suitable machine learning technique, for example using one or more data fitting and/or machine learning techniques, such as SVM (Support Vector Machine), Regression Tree, or CNN (Convolutional Neural Network).

In other words an inference model is determined into which a spatial arrangement of objects within a fabrication chamber (or features extracted therefrom) can be input and which will output an indication of (predicted or estimated) thermal interaction. The model is based on training data which may be, in whole or in part, based on simulated build volumes (i.e. build volumes which may have never actually been built, but which may be based on data characterising ‘real’ build volumes, and therefore may provide good indications of real use cases). The inference model may associate features of spatial arrangements of objects with thermal interactions.

Such an inference model may be able to output an indication of thermal interaction in a significantly shorter time than it would take to perform a simulation to determine the indication of thermal interaction. In some examples a simulation to obtain the indication of thermal interaction may take an hour or more to perform whereas the corresponding inference model may obtain an estimate of the thermal interaction in several seconds (for example less than 5 seconds, or less than 1 second) using comparable processing resources.

FIG. 4 is an example of a method, which may comprise a computer implemented method for selecting a spatial arrangement of objects to be generated in additive manufacturing.

The method comprises, in block 402 receiving, at at least one processor, a plurality of spatial arrangements of objects to be generated in additive manufacturing. The received spatial arrangements may be candidate spatial arrangements for use in generating the objects. The spatial arrangements may be obtained by randomly arranging virtual models of objects to be generated within a build volume, while avoiding collisions between virtual objects. In other examples the virtual objects may be arranged non-randomly, for example a random spatial arrangement of objects may be taken, then the virtual objects moved until each object is within a threshold distance of another object. In other examples a predetermined set of rules is followed to place the virtual objects in a spatial arrangement to provide a ‘good’ spatial arrangement. A ‘good’ spatial arrangement may be one in which there are no collisions and/or the minimum distance between virtual objects is between a lower threshold and an upper threshold. In some examples, such an arrangement may alternatively or additionally favour placing larger virtual objects at the bottom of the build volume with smaller objects above. In some examples, an initial arrangement may have a fairly homogenous distribution of virtual objects. Such arrangements have been found to have relatively good thermal interaction indications or scores as they may result in relatively less extreme temperature gradients and/or less thermal stress than may be seen in other arrangements.

Block 404 comprises determining for each spatial arrangement, using at least one processor, an indication of thermal interaction based on an inference model. In some examples the inference model may be created using the method described in relation to FIG. 1 or FIG. 3. The inference model may take as its input a model of a candidate spatial arrangement of objects within a build volume, or features extracted therefrom. Such a model of a candidate spatial arrangement may be a mesh model, a voxelised model or comprise a simplified model such as a model comprising a set of features extracted from a mesh model or voxelised model and/or based on object parameters. For example, this may comprise at least one feature relating to object geometry, at least one feature relating to relative object placement, and/or at least one feature relating to object generation parameters. When such information is provided to the inference model, the inference model (or prediction model) may then output an estimate of an indication of thermal interaction.

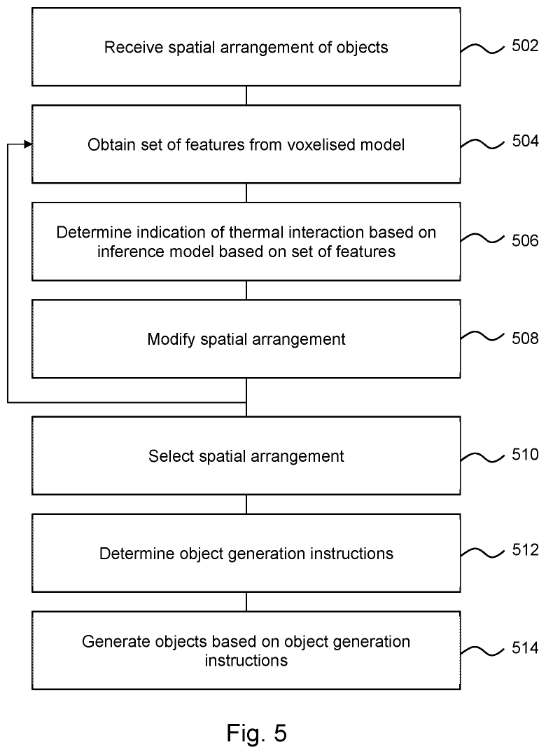

Block 406 comprises selecting a spatial arrangement based the indications of thermal interaction. A spatial arrangement may be selected based on the indication of thermal interaction, for example the spatial arrangement which results in the least thermal interaction may be selected. In other examples additional criteria may also be used when selecting a spatial arrangement as described in more detail with respect to FIG. 5.

FIG. 5 is an example of a method, which may comprise a computer implemented method for selecting and determining a spatial arrangement for objects in additive manufacturing, and generating the objects.

Block 502 comprises receiving, at at least one processor, a spatial arrangement of objects to be generated in additive manufacturing, and may correspond to block 402 of FIG. 4. In some examples, a plurality of spatial arrangements may be received.

Block 504 comprises obtaining a set of features of a three-dimensional model of a fabrication chamber of an additive manufacturing apparatus comprising the spatial arrangement of objects. The features may be extracted from a model of a spatial arrangement of objects in a fabrication chamber. Such a model may be highly detailed and therefore comprise a large amount of data which can be challenging to process efficiently. Therefore, by extracting significant features from the model (which may also be, or include, the features used when determining the inference model) a reasonable estimate of the indication of thermal interaction may be achieved without the challenges associated with processing large quantities of data. The set of features may describe features which relate to the thermal behaviour of an additive manufacturing operation. In a particular example, the set of features comprises (i) the location of the centre of mass (for example in x, y, z coordinates); (ii) surface area of the objects, (iii) volume of the objects, (iv) convex hull area; (v) convex hull volume and (vi) at least one parameter of the build material (e.g, its thermal properties, or its identity).

In this example the set of features are extracted from a voxelised model of a fabrication chamber contents describing which voxels correspond to sub-volumes with the fabrication which are to be solidified when generating the objects.

In some examples the set of features comprise at least one of: relative positions of objects in the additive manufacturing fabrication chamber, geometrical properties of the objects (e.g. volumes of the objects and/or moments of inertia of the objects) and/or parameters of additive manufacturing (such as an indication of materials to be used in generating the objects). By extracting a set of features, the amount of data which is to be processed can be significantly reduced. Such features may provide sufficient information for the inference model to provide a good estimate of the indication of thermal interaction. In an example the features obtained comprise the location of the centre of mass (for example in x, y, z coordinates), surface area of the objects, volume of the objects, convex hull area and convex hull volume, wherein a convex hull is a convex surface enclosing an object, and an indication of at least one attribute of a build material (e.g. its thermal diffusivity or identity). Other factors may also or alternatively be considered, as discussed above.

Block 506 comprises determining, for a spatial arrangement, an indication of thermal interaction based on an inference model (which may also be referred to as a prediction model). The indication is determined based on the obtained set of features. For example the obtained set of features may be input to an inference model which has been trained using similar- or the same-features, such that the inference model does not rely on a full use of a full voxelised model as an input. The inference model in this example outputs the indication of thermal interaction.

Block 508 comprises modifying the received spatial arrangement prior to selecting a spatial arrangement based on the indications of thermal interaction. The spatial arrangement may be modified by changing the position of an object, or objects, of the spatial arrangement with the aim of improving the spatial arrangement, for example to achieve a better indication of thermal interaction. The modified spatial arrangement may then be used as the basis of an input to the inference model to determine an indication of thermal interaction for the modified spatial arrangement to determine if the indication of thermal interaction has improved. In other examples, in which there are a plurality of spatial arrangements, a new spatial arrangement may be selected, and/or aspects of different spatial arrangements may be combined.

The method then loops back to block 504, extracting a new set of features (while noting that some features may be common to a plurality of object generation operations) wherein an indication of thermal interaction is determined based on the inference model for a different spatial arrangement. Blocks 504, 506 and 508 may be repeated for each of the received spatial arrangements. In this example the indications of thermal interaction are determined sequentially for each spatial arrangement, however the determination may be made in parallel such that indications of thermal interaction are determined for different spatial arrangements concurrently.

In some examples, a spatial arrangement is iteratively modified, for example by use of a ‘genetic’ process. A spatial arrangement may be obtained and from that spatial arrangement a plurality of candidate spatial arrangements obtained. For example, objects of the spatial arrangement may be moved to produce each candidate spatial arrangement by changing their position and/or orientation. An indication of thermal interaction may then be determined for each of the candidate spatial arrangements, for example based on the extracted set of features. A candidate spatial arrangement may then be selected based at least partly on the indication of thermal interaction for a further iteration of the genetic process. The selected candidate spatial arrangement can be modified as described previously, and for each subsequent modified spatial arrangement an indication of thermal interaction may be determined. This process can be repeated in an iterative manner to obtain a spatial arrangement which has a better indication of thermal interaction than the initial spatial arrangement. Other selection criteria may also be used in selecting a spatial arrangement at each iteration. The process may iterate for a predetermined period of time (e.g. for 2 minutes), and then a spatial arrangement selected from the plurality of determined spatial arrangements based at least in part on the indication of thermal interactions. In some examples several instances of such a process may be run in parallel, for example on different processing cores, and the best overall spatial arrangement can then be selected from all the generated spatial arrangements. In some examples, aspects of more than one spatial arrangement may be combined to create a modified spatial arrangement. The iterative modifications may be performed and selected according to any suitable simulated annealing optimization or genetic optimization.

When an indication of thermal interaction has been determined for each spatial arrangement, the method continues to block 510, which comprises selecting a spatial arrangement based, at least in part, on the indications of thermal interaction, and which may correspond to block 406 of FIG. 4.

In some examples selecting a spatial arrangement is based on at least one of: avoidance of collisions between objects within the fabrication chamber, a number of objects which fit in a fabrication chamber for a spatial arrangement, a number of objects in the fabrication chamber in each spatial arrangement, heights of the objects and/or a depth of build material used to build objects in each spatial arrangement. In some examples selecting the spatial arrangement may consider hardware constraints, for example a spatial arrangement may not be selected if it results in a particular object or object portion being located in a position within the build volume which is known to produce inaccurate dimensions. For example, a spatial arrangement which allows all of, or as many as possible of, the objects to be generated in a single additive manufacturing process may be selected in preference to a spatial arrangement which does not fit all the objects in a single build volume. In some examples the selection may favour spatial arrangements which reduce use of build material by selecting a spatial arrangement with a low depth of build material. Examples of metrics are discussed in greater detail below.

Block 512 comprises determining object generation instructions for generating the objects to be generated in the selected spatial arrangement, the object generation instructions specifying an amount of agent, such as print agent, fusing agent or detailing agent, to be applied to each of a plurality of locations on a layer of build material. For example, determining print instructions may comprise determining ‘slices’ of a virtual fabrication chamber containing virtual objects arranged in the selected spatial arrangement, and rasterising these slices into pixels (or voxels, i.e. three-dimensional pixels). An amount of print agent (or no print agent) may be associated with each of the pixels/voxels. For example, if a pixel/voxel relates to a region of a fabrication chamber which is intended to solidify, the print instructions may be determined to specify that fusing agent should be applied to a corresponding region of build material in object generation. If however a pixel/voxel relates to a region of the fabrication chamber which is intended to remain unsolidified, then print instructions may be determined to specify that no agent, or a coalescence modifying agent such as a detailing agent, may be applied thereto. In addition, the amounts of such agents may be specified in the print instructions and these amounts may be determined based on, for example, thermal considerations and the like.

Block 514 comprises generating the objects based on the object generation instructions. For example, this may comprise forming a layer of build material, applying print agents, for example through use of ‘inkjet’ liquid distribution technologies in locations specified in object model data for an object model slice corresponding to that layer using at least one print agent applicator, and applying energy, for example heat, to the layer. Some techniques allow for accurate placement of print agent on a build material, for example by using printheads operated according to inkjet principles of two-dimensional printing to apply print agents, which in some examples may be controlled to apply print agents with a resolution of around 600 dpi, or 1200 dpi. A further layer of build material may then be formed and the process repeated, for example with the object model data for the next slice.

In some examples selecting a spatial arrangement is performed by considering a metric which describes how good a particular spatial arrangement is based on various properties of the spatial arrangement. Such a metric may take into account whether all the objects to be generated can fit in the fabrication chamber, and if they cannot fit how many objects are unable to fit in the fabrication chamber. The metric may also take into account the heights of the objects to be generated, for example it may take account of an average height of objects to be generated such as the mean height of the objects.

The metric may take account of the amount of build material which is used for that particular spatial arrangement, for example it may consider the depth of build material used. The metric may also take account of the indication of thermal interaction.

The metric may be described for example by determining a value such as e^{ρ} (αh̅+βb+γθ), wherein ρ is the number of objects of an intended number of objects which cannot fit in the build volume for that spatial arrangement (for example if it is intended to build 10 objects and a maximum of 8 can fit in the build volume, then ρ=2), α is a factor describing the importance of the average height of objects, β is a factor describing the importance of the maximum height of objects, γ is a factor describing the importance of the indication of thermal interaction, h̅ is the average height of the objects, b is a measure of the amount of build material used and θ is the indication of thermal interaction. The various ‘importance’ factors may for example vary according user preference and/or use case. A spatial arrangement may therefore be selected by selecting the spatial arrangement for which the above value is lowest. In this example the number of objects which cannot fit in the build volume is included as an exponential factor, so that it rapidly increases when objects cannot be fitted. This is because a spatial arrangement in which objects cannot fit in the build volume means a further build process is performed to build the remaining objects which significantly increases the time and cost of manufacturing the objects.

In some examples selecting a spatial arrangement is performed by selecting the spatial arrangement with the minimum value of:

$${e}^{ρ} \times ( α \frac{{Σ}_{i = 0}^{n} {Z}_{i}}{n} + β \frac{max ( Z )}{ϑ} + γ θ )$$

wherein ρ is the number of objects to be built minus the number of objects which fit in the fabrication chamber for that spatial arrangement, Zᵢ are the heights of each object, max(Z) is the depth of build material used, [symbol] is the maximum achievable depth of build material, θ is the indication of thermal interaction, n is the number of objects, a is a factor describing the importance of the average height of objects, β is a factor describing the importance of the maximum height of objects and γ is a factor describing the importance of the indication of thermal interaction. In the example of FIG. 2 ρ equals 0 since all five objects fit within the fabrication chamber, max(Z) is the actual depth 216 of build material used, [symbol] is the maximum depth 214 and n equals 5.

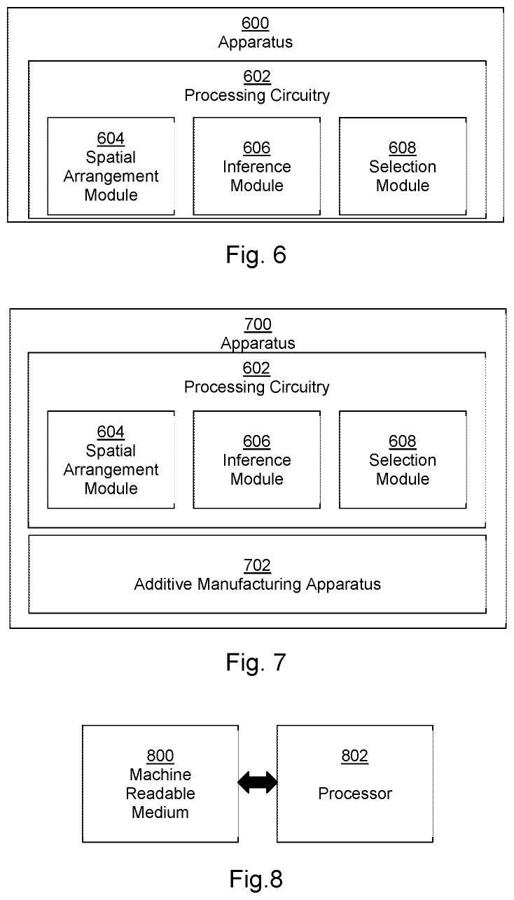

FIG. 6 shows an example of apparatus 600 comprising processing circuitry 602. The processing circuitry 602 comprises a spatial arrangement module 604, an inference module 606 and a print instructions module 608.

In use of the apparatus 600, the spatial arrangement module 604 obtains a plurality of spatial arrangements of objects to be generated using additive manufacturing. The spatial arrangements may be obtained as described in relation to FIG. 5, and may represent different modifications based on at least one initial spatial arrangement of the objects to be generated.

The inference module 606, in use of the apparatus 600, is to infer, for each of the plurality of spatial arrangements, a thermal score. The thermal score may be indicative of the predicted thermal behaviour of the spatial arrangement, and/or a good thermal score may be associated with an increased likelihood of a good, or more successful object generation operation (e.g. generation of objects having more accurate dimensions). The thermal score may have any of the attributes of the indication of thermal interaction described above. The inference model may be obtained by use of the training set described in relation to FIG. 1, for example by the methods described in relation to FIG. 3. The inference model 606 may receive inputs in the form of a set of features of the spatial arrangements.

The selection module 608, in use of the apparatus 600, is to select a spatial arrangement at least partially based on the thermal score. Such selection may for example be performed as described in relation to FIG. 4 or 5.

FIG. 7 shows an example of an apparatus 700, which comprises the processing circuitry 602 of FIG. 6. The apparatus 700 further comprises an additive manufacturing apparatus 702 to generate objects according to the spatial arrangement selected by the selection module 608.

The additive manufacturing apparatus 702 may further comprise a print instruction module, which in use of the additive manufacturing apparatus determines print instructions for generating the objects having the spatial arrangement.

The print instructions (or object generation instructions) may, in use thereof, control the additive manufacturing apparatus 702 to generate each of a plurality of layers of the object. This may for example comprise specifying area coverage(s) for print agents such as fusing agents, colorants, detailing agents and the like. In some examples, object generation parameters are associated with object model sub-volumes (voxels or pixels). In some examples, the print instructions comprise a print agent amount associated with sub-volumes. In some examples, other parameters, such as any, or any combination of heating temperatures, build material choices, an intent of the print mode, and the like, may be specified. In some examples, halftoning may be applied to determine where to place fusing agent or the like.

The additive manufacturing apparatus 702 may, in use thereof, generate an object in a plurality of layers (which may correspond to respective slices of an object model) according to the print instructions. For example, this may comprise generating at least one object in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. The apparatus 702 may comprise additional components not shown herein, for example any or any combination of a fabrication chamber, a print bed, printhead(s) for distributing print agents, a build material distribution system for providing layers of build material, energy sources such as heat lamps and the like.

FIG. 8 shows a machine readable medium 800 associated with a processor 802. The machine readable medium 800 comprises instructions which, when executed by the processor 802, cause the processor 802 to carry out any of the blocks of FIG. 1, FIG. 3, FIG. 4 or FIG. 5 or may cause an additive manufacturing apparatus to carry out any of the blocks of FIG. 4 or FIG. 5. In some examples, the instructions may cause the processor to act as any part of the processing circuitry 602 of FIG. 6 or FIG. 7.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining a training dataset for an inference model to evaluate spatial arrangements of objects to be generated in additive manufacturing, wherein determining the training dataset comprises:
obtaining, by at least one processor, a temperature distribution for each of a plurality of spatial arrangements of objects to be generated in additive manufacturing; and
obtaining, using at least one processor, an indication of thermal interaction for each spatial arrangement based on the obtained temperature distribution.

2. A method according to claim 1 further comprising:
using the training dataset and at least one processor to determine an inference model which is to indicate, for a given spatial arrangement of objects within a fabrication chamber during object generation, an indication of thermal interaction.

3. A method as claimed in claim 2 comprising obtaining, using at least one processor, a set of features of each spatial arrangements; and wherein the inference model is to associate indications of thermal interaction with sets of features.

4. A method as claimed in claim 1 wherein obtaining the temperature distribution comprises:
performing, for each of the spatial arrangements, a simulation to model the temperature distribution.

5. A method comprising:
receiving, at at least one processor, a plurality of spatial arrangements of objects to be generated in additive manufacturing;
determining, for each spatial arrangement, using at least one processor, an indication of thermal interaction based on an inference model; and
selecting, using at least one processor, a spatial arrangement based on the indications of thermal interaction.

6. A method as claimed in claim 5 further comprising:
obtaining, using at least one processor, a set of features of a three-dimensional model of a fabrication chamber of an additive manufacturing apparatus comprising the spatial arrangement of objects, and
wherein the determining is based on the obtained set of features.

7. A method as claimed in claim 6, wherein the set of features are extracted from a voxelised model of a fabrication chamber contents describing which voxels correspond to sub-volumes within the fabrication chamber which are to be solidified when generating the objects.

8. A method as claimed in claim 6, wherein the set of features comprise at least one of:
relative positions of objects;
volumes of the objects;
geometrical properties of the objects;
moments of inertia of the objects; and/or
materials to be used in generating the objects.

9. A method as claimed in claim 5 wherein selecting is based on at least one of:
avoidance of collisions between objects within the fabrication chamber;
a number of objects which fit in a fabrication chamber for a spatial arrangement;
a number of objects in the fabrication chamber in each spatial arrangement;
heights of the objects; and/or
a depth of build material used to build objects in each spatial arrangement.

10. A method as claimed in claim 5 wherein selecting is performed by selecting the spatial arrangement with the minimum value of the equation:
$${e}^{ρ} \times ( α \frac{{Σ}_{i = 0}^{n} {Z}_{i}}{n} + β \frac{max ( Z )}{ϑ} + γ θ )$$
wherein ρ is the number of objects to be built minus the number of objects which fit in the fabrication chamber for that spatial arrangement, Zᵢ are the heights of each object, n is the number of objects, max(Z) is the depth of build material used, ϑ is the maximum achievable depth of build material, θ is the indication of thermal interaction, α is a factor describing the importance of the average height of objects, β is a factor describing the importance of the maximum height of objects and γ is a factor describing the importance of the indication of thermal interaction.

11. A method as claimed in claim 5 further comprising:
modifying each of the received spatial arrangements prior to selecting a spatial arrangement based on the indications of thermal interaction.

12. A method according to claim 5 further comprising:
determining object generation instructions for generating the objects to be generated in the selected spatial arrangement, the object generation instructions specifying an amount of agent to be applied to each of a plurality of locations on a layer of build material.

13. A method as claimed in claim 12 further comprising:
generating the objects based on the object generation instructions.

14. An apparatus comprising processing circuitry, the processing circuitry comprising:
a spatial arrangement module to obtain a plurality of spatial arrangements of objects to be generated using additive manufacturing;
an inference module, to infer, for each of the plurality of spatial arrangements, a thermal score; and
a selection module to select a spatial arrangement at least partially based on the thermal score.

15. An apparatus as claimed in claim 14 further comprising:
an additive manufacturing apparatus to generate objects according to the selected spatial arrangement.
